(19) United States
(12) Patent Application Publication
(10) Pub. No.: US 2012/0271676 A1
(43) Pub. Date: Oct. 25, 2012

(54) SYSTEM AND METHOD FOR AN INTELLIGENT PERSONAL TIMELINE ASSISTANT

(76) Inventors: Murali ARAVAMUDAN, Windham, NH (US); Daren GILL, Concord, MA (US); Girish WELLING, Nashua, NH (US); Sashikumar VENKATARAMAN, Andover, MA (US); Rakesh BARVE, Bangalore (IN)

(21) Appl. No.: 13/454,515

(22) Filed: Apr. 24, 2012

Related U.S. Application Data
(60) Provisional application No. 61/478,608, filed on Apr. 25, 2011.

(51) Int. Cl. G06Q 10/06

(52) U.S. Cl. 705/7.18

(57) ABSTRACT

The present disclosure provides methods and systems for assisting a user in managing a timeline of appointments in which at least one appointment is associated with an event, and the appointment has associated appointment information that describes aspects of the appointment and/or event, including receiving free-form scheduling information from an electronic notification, inferring that at least a portion of the free-form scheduling information relates to an existing appointment and/or associated event, the existing appointment having presently associated appointment information that describes aspects of the appointment and/or associated event, selecting an appointment for modification, and modifying the selected appointment based on (a) the portion of the free-form scheduling information inferred to relate to the existing appointment and/or associated event, and at least one of the appointment information presently associated with the existing appointment, and a user preference signature representing prior actions performed by and/or content preferences learned about the user.

### CROSS-REFERENCE TO RELATED APPLICATION

This application claims the benefit under 35 U.S.C. §119(e) of Provisional Application Ser. No. 61/478,608, filed Apr. 25, 2011, entitled System and Method for an Intelligent Personal Timeline Assistant, the contents of which are incorporated by reference herein.

### FIELD OF THE DISCLOSURE

The present invention relates to systems and methods for assisting user in managing a timeline of tasks or appointments, and, more specifically, creating, augmenting, and/or modifying a timeline of appointments as the status of the user and/or the tasks change.

### BACKGROUND OF THE DISCLOSURE

### Description of Related Art

The desire to create an automated agent to help in users' business and personal lives, particularly with tasks that are not demanding on the intellect but nevertheless important for smooth functioning of our lives, has remained an elusive goal to date. Perhaps the replacement of a human personal assistant by an automated agent may remain an elusive goal for a long time to come, not only because of the richness of interaction with a human agent, but the inherent edge human intelligence has in understanding context. For example, a personal secretary is unlikely to recommend a night at the opera to fill the evening on an overnight post-business meeting stay, if he or she is aware his or her boss has just suffered a personal loss. The secretary may deduce this personal loss from a terse email response to some normal matter of business.

Several innovations for tasks, calendar, and appointment scheduling or rescheduling, combined with personal devices having large amounts of memory, have made it possible even for those leading busy lives without the benefit of human personal assistants to live efficiently, should users choose to leverage these innovations.

However, the efficiency brought into one's life by an assortment of these tools is still quite wanting, even for the most organized users, when it comes to managing a sequence of events leading to and following a key event. For example, a key event may include a business meeting. Events leading up to and following the business meeting might include taking a flight, picking up a rental car, attending a meeting, checking into a hotel, staying overnight, returning the rental car, and flying back home. Such a sequence of events can be complicated. Furthermore, this example does not include mixing business with pleasure.

Even the most organized business traveler, with an array of membership cards (in digital or physical form) to avoid long waiting queues, would acknowledge an unfulfilled desire of innumerable small things that would make travel easier. Oddly, a significant chunk of these innumerable small desirable unfulfilled things can be broadly categorized as “simple mundane things that can be addressed by being even more organized.” Perhaps it is the sheer volume of these little items, despite it being only a matter of being more organized, that make it hard for even the most organized business traveler to focus just on the main tasks (e.g., making sure email confirmations and membership cards are easily accessible) and leave the rest unfulfilled. The list of unfulfilled items and the degree to which the individual thinks of the items as “mild tolerable stress or the nuisance of travel” varies according to the individual. Some of these unfulfilled items include (a) knowing the weather at the destination city so as to dress accordingly—a chore that one can regret if it is not taken into consideration when traveling to or living in a city with capricious weather patterns, (b) establishing whether a confirmation e-mail for a hotel reservation (which came a few days ago, and was not filed separately) is available in a phone's cache for quick access when checking in—a challenge because many e-mails have come since then, making it possible the confirmation e-mail no longer is in the phone cache, (c) determining whether a car rental agency has cars with navigation help to avoid having to use a map application on one's mobile device (for fear of high roaming data costs), and the list goes on.

While most users largely tolerate the items described above, even the seasoned business traveler would gladly welcome help when things don't go as planned. For example, if a traveler is en route to an airplane and the traveler has been delayed due to traffic congestion, and travel plans do not permit the usual slack time factored into normal travel plans, the traveler might appreciate a reminder to make a phone call to notify others that he or she is running late.

Mixing pleasure with business is a necessity and not a luxury for those who spend a large amount of time on the road. Again, this is an area where help is wanting. Especially in big cities, particularly for popular shows, concerts, and/or dining places, reserving in advance is essential to avoid disappointment. Here planning ahead comes into play again, as an example of one more thing to do in advance before a trip. In parallel to all the planning demanded by the business facet of one's life, one has to plan and act in advance for important events in the personal side of one's life as well.

To summarize, when it comes to business travel where many events have to occur in sequence, even the most organized person would find additional help very welcome, even though most of which can be broadly classified as “being more organized.” Even more welcome would be any help, even if only a small amount, in situations in which events do not proceed as planned. Lastly, assistance in making a trip memorable by mixing pleasure with business would only make the dependency on such an agent greater, if not vital, to improve one's quality of life.

### SUMMARY OF THE DISCLOSURE

The present disclosure provides user interface methods of and systems for assisting a user in managing a timeline of appointments in which at least one of the appointments is associated with an event, and the appointment has associated appointment information that describes aspects of the appointment and/or the event, including receiving free-form scheduling information from an electronic notification, inferring that at least a portion of the free-form scheduling information relates to an appointment existing on a timeline of appointments and/or an event associated with the existing appointment, the existing appointment having presently associated appointment information that describes aspects of the appointment and/or the associated event, selecting an appointment for modification, and modifying the selected appointment based on (a) the portion of the free-form scheduling information inferred to relate to the existing appointment and/or the associated event, and (b) at least one of (i) the appointment information presently associated with the existing appointment, and (ii) a user preference signature representing prior actions performed by the user and/or content preferences learned about the user.

Under another aspect of the invention, the existing appointment and/or the selected appointment includes (i) appointment information that describes aspects of the appointment and/or the associated event, (ii) an action to be performed on behalf of the user, (iii) a notification to update the user, and/or (iv) a suggested action for the user to take.

Under another aspect of the invention, the electronic notification includes an email message, a calendar appointment, a task, an application, notes application data, a social network event, a web site event, a text message, an electronic communication, and/or location information of the user.

Under another aspect of the invention, the associated appointment information includes an event type, one or more individuals involved with the event, location information about the event, and/or temporal information about the event.

Under another aspect of the invention, the modifying the selected appointment includes identifying ambiguous appointment information in the selected appointment, and identifying at least one suggested clarification to the ambiguous appointment information based on the portion of the free-form scheduling information.

Under a further aspect of the invention, the modifying the selected appointment further includes receiving confirmation from the user on whether the suggested clarification resolves the ambiguous appointment information, and updating the selected appointment based on the suggested clarification and on the confirmation from the user.

Under another aspect of the invention, the modifying the selected appointment further includes concluding that the suggested clarification resolves the ambiguous appointment information based on exceeding a confidence threshold, and updating the selected appointment based on the suggested clarification.

Under another aspect of the invention, the identifying at least one suggested clarification is based on free-form text entered in a description of the selected appointment.

Under another aspect of the invention, the modifying the selected appointment is based on a location constraint and/or a time constraint.

Under another aspect of the invention, the present disclosure provides user interface methods of and systems for assisting a user in managing a timeline of appointments in which at least one of the appointments is associated with an event, and the appointment has associated appointment information that describes aspects of the appointment and/or the event, including receiving free-form scheduling information from an electronic notification, inferring that at least a portion of the free-form scheduling information relates to a new appointment to be created on a timeline of appointments, the new appointment being associated with an event, determining appointment information for the new appointment based on (i) the portion of the free-form scheduling information inferred to relate to the new appointment and/or the associated event, and (ii) a user preference signature representing prior actions performed by the user and/or content preferences learned about the user, and creating the new appointment using the determined appointment information.

Under another aspect of the invention, a system for assisting a user in managing a timeline of appointments in which at least one of the appointments is associated with an event, and the appointment has associated appointment information that describes aspects of the appointment and/or the event includes a computer memory store comprising instructions in computer readable form that when executed cause a computer system to perform any of the actions set forth above.

Any of the above aspects may be combined with any of the other aspects above.

### BRIEF DESCRIPTION OF THE DRAWINGS

Embodiments of the present disclosure and their advantages may be understood by referring to FIGS. 1-7, wherein like reference numerals refer to like elements.

For a more complete understanding of various embodiments of the present invention, reference is now made to the following descriptions taken in connection with the accompanying drawings in which:

FIG. 1 illustrates a personal timeline assistant system in accordance with some embodiments.

FIG. 2 illustrates an embodiment of the present personal timeline assistant system where some of the services required by the present personal timeline assistant are resident on a remote server, while the remaining portion of the present system is resident on a mobile device.

FIG. 3 illustrates an embodiment of the personal timeline assistant system where the mobile device serves purely as an events aggregator and rendering interface.

FIG. 4 illustrates an embodiment of an event timeline with two independent threads of appointments, with the dependency graph of both of them mapped on a single event timeline honoring time and location constraints.

FIG. 5 illustrates creation of the timeline from events received from disparate data sources and occurring in a temporal order in accordance with some embodiments.

FIG. 6 illustrates a user interface shown when a user travels to San Jose for a meeting in accordance with some embodiments.

FIG. 7 illustrates a user interface shown when a user is at a home city in Massachusetts in accordance with some embodiments.

### DETAILED DESCRIPTION OF EMBODIMENTS

The techniques set forth herein accurately translate appointment sequences involving a user in different events such as activities or actions, with time and location constraints, into a computable form that can facilitate automated offers of help or assistance, and can tailor the assistance to the user's preferences learned from past actions.

The present disclosure includes a system and method for assisting a user in managing a timeline of tasks or appointments. The tasks or appointments generally represent events that require user involvement in person or otherwise. The tasks or appointments can be business and/or personal, where the tasks or appointments are in most cases scheduled to occur in the future. Example tasks or appointments are a sequence of different activities or actions involving a user, including catching a plane, picking up a rental car, attending a meeting physically or virtually, joining a conference call, or calling home to wish a child happy birthday. Alternatively, some tasks or appointments can occur in the past, if the user missed them.

The present system infers and interprets appointment information (hereinafter “metadata”) relevant to tasks or appointments (hereinafter collectively “appointments”) from electronic notifications from disparate event sources. Electronic notifications arrive from event sources including, for example, email, calendar events, to-do lists, text messages or instant messages (IM), social networks, event planning websites, phone call logs, and user interactions.

Embodiments of the present system receive free-form scheduling information in addition to information expressly designated as appointment-related information. As described above, electronic notifications arrive from disparate event sources including email, calendar events, to-do lists, text messages or instant messages (IM), social networks, event planning websites, phone call logs, and user interactions. Unlike traditional calendaring systems in which a user might send a specially formed request having expressly designated appointment-related information to reschedule a calendar meeting, the present system receives free-form scheduling information and infers that a portion of the free-form scheduling information relates to an appointment on the timeline. For example, if a traditional email system receives an email message requesting that a user reschedule a meeting, the user must then enter the calendar system and reschedule the meeting as requested. In contrast, the present system is able to infer that the email message relates to a calendar meeting and reschedule the meeting automatically. Such free-form scheduling information may be included in the electronic notification along with other information that is not necessarily related to the event and/or appointment.

Treating these disparate sources as free-form feeds supplying a continuous stream of appointment information (or metadata) on appointments, the present system assembles and incrementally maintains a single appointment timeline composed of one or more independent appointment threads and updates this timeline based on semantics progressively inferred over time from data streams about the appointments. Example appointment information includes temporal information, location information, and/or free-form information fragments. Example free-form information fragments include clues to decipher specific names of points of interest, names of people attending a meeting, reminders of a child's birthday from spouse, or an identity of an outgoing or incoming or missed call. In some embodiments, the present system represents each appointment thread by a dependency graph of appointments.

The present system dynamically generates synthetic appointments using a signature of a user's past actions and injects them into the appointment timeline, honoring time and space constraints. The system also offers suggestions to help the user in timely attending the appointments (and in cases where an appointment is missed, offers suggestions to remedy them based on the nature of the appointment that was missed). System-offered suggestions can be based on the nature of the appointment, time, location, and/or signature of user's past interactions. As used herein, the term “signature” represents a set of data about a user's preferences and/or past behaviors. Techniques for generating a user signature based on user preferences, activities, and behavior include, but are not limited to, those disclosed in U.S. Pat. No. 7,792,815, entitled Methods and Systems for Selecting and Presenting Content based on Context Sensitive User Preferences, filed Mar. 6, 2007, and U.S. Pat. No. 7,949,627, entitled Methods and Systems for Selecting and Presenting Content based on Learned Periodicity of User Content Selection, filed Jul. 26, 2010, the contents of which are incorporated by reference herein. An illustrative set of example suggestions include the following use case in which the user is running late for an appointment: displaying a phone number of a person with whom an appointment is due upon landing in the city where a meeting is scheduled to occur (e.g. to help notify that person of a delay in arriving at the appointment), showing a map with directions to drive to the appointment as soon as the user lands at an airport close to the destination of appointment, and/or recommending restaurants that match user's signature in the city to which the user is travelling for the appointment.

The present methods and systems also include providing implicit and explicit notifications to further assist the user, such as proactively sending an automated message to select participants of a meeting, informing them that the user is delayed and is in transit on a flight for the meeting. In this example, the message is an unsolicited message dispatch and/or an automated response dispatch in response to an electronic notification such as a message from a select list of users who are participants of the meeting which the user is supposed to be attending.

In addition to generating synthetic events, offering suggestions, and performing notifications, in some embodiments the present system performs actions or transactions for or on behalf of the user. The result of such an action or transaction is, in turn, a synthetic appointment injected into the timeline or a notification to the user of the outcome of the action or transaction. For example, an action or transaction includes purchasing a ticket for a concert or movie using online automated ticketing services (e.g., TICKETMASTER and/or FANDANGO), or making a restaurant reservation for a favorite restaurant of the user using an Application Programming Interface (API) for a restaurant reservation service (e.g., OPENTABLE).

In much the same way a car navigation system re-computes and announces a new route when the driver has deviated off the original suggested route, the present system re-evaluates the timeline periodically at regular time intervals. Thus, when the user's location changes, a new appointment comes in, and/or an update to an existing appointment happens, the scheduling system, if necessary, recalibrates or regenerates the synthetic appointments (identifying and resolving conflicts in space and time), offers new suggestions, and/or performs notifications and actions to assist the user in accomplishing the updated timeline of appointments.

The present system renders the generated single appointment timeline, composed of externally driven and synthetically generated appointments, in a variety of ways ranging from traditional calendar-like interfaces to new user interfaces. The present disclosure includes illustrative implementations of such new interfaces that capture dynamic aspects of the event timeline along with suggestions and notifications. In some embodiments, factors causing dynamic changes include (1) time, (2) location of the user, and/or (3) appointment information pertaining to appointments inferred from disparate electronic notifications or event source streams as mentioned earlier.

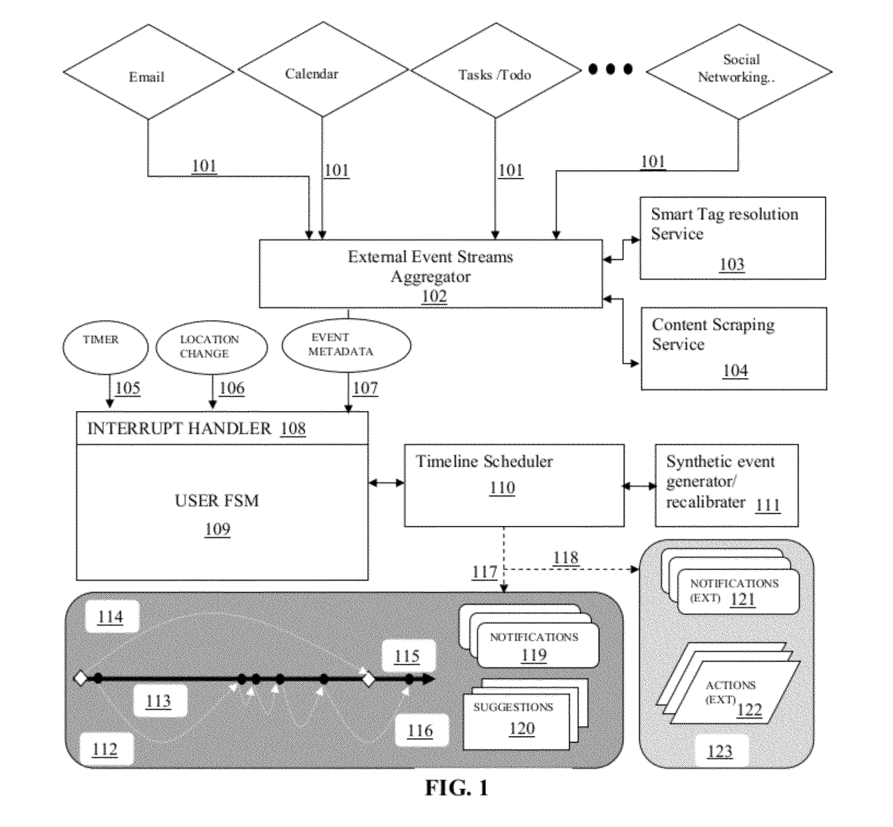

Turning now to the drawings, FIG. 1 illustrates a personal timeline assistant system in accordance with some embodiments. FIG. 1 includes event sources 101, an event stream aggregator 102, smart tag resolution service 103, content scraping service 104, timer 105, location change 106, metadata 107, interrupt handler 108, finite state machine 109, scheduler 110, event generator/recalibrater 111, timeline 113, appointment threads 114 and 116, appointment nodes 115, interfaces 117 and 118, notifications 119, suggestions 120, external notifications 121, and external actions 122. The present system uses event stream aggregator 102 to aggregate and infer appointment information from disparate electronic notifications or event sources 101. The inferred appointment information serves as metadata 107 for appointments that get mapped on to appointment timeline 113. The appointment information inferred from these electronic notifications can be broadly classified into (1) time—information about when an event is happening and its duration, (2) location—where the event is happening, (3) nature of the event—the comprehension of the nature of the event is at a concrete level of deducing smart tags (or, loosely, nouns or phrases) that help classify the type of the event, and other attributes of the event such as the participants in the event, etc. Techniques for associating content with smart tags include, but are not limited to, those disclosed in U.S. patent application Ser. No. 12/879,141, filed Sep. 10, 2010, entitled Method of and System for Presenting Enriched Video Viewing Analytics, which is incorporated by reference herein. In some embodiments, the present system uses semantics of the nature of the event to infer dependencies of this event on other events.

Data sources for this appointment information represent an ongoing stream of information, some of which are, but are not limited to, email, calendar events, tasks applications, notes application data, social networking applications, and/or web sites. Event aggregator 102 works in conjunction with smart tag resolution service 103 which can resolve and disambiguate smart tags from these disparate sources to infer meaning such as free-form scheduling information. Example free-form scheduling information includes whether an appointment mentions a name of a place, etc. Event aggregator 102 further works in conjunction with content scraping service 104 that parses and infers information from web sites of travel services, airlines, etc. to facilitate resolution of smart tags resolved by smart tag resolution service 103 as described above.

The present system responds to three types of interrupts: (1) timer 105, (2) location change 106, and (3) availability of new appointment information or event metadata 107 from any of the event sources mentioned earlier. Interrupt handler 108 of Finite State Machine (FSM) 109 delegates the appropriate interrupt handler to act on this input. FSM 109 handles interrupts from the categories mentioned above and dispatches schedule entries to timeline scheduler 110 with location and time information accompanying any appointment information for an appointment. In some devices, processing location update events requires high power usage which drains battery life. In such devices where location update events are expensive in terms of battery life, in some embodiments FSM 109 functions optimally by not registering for location updates. Instead, when location update events arrive to the present system, FSM 109 queries for the current location, and dispatches the update after receiving the current location (assuming the response to the location request is ansychronous).

FSM 109 works in conjunction with timeline scheduler 110, which in turn works in conjunction with synthetic event generator/recalibrater 111, to (1) update appointment timeline 113 with appointments (over interface 117), reflecting dependencies between appointments, and (2) regenerate notifications 119 and suggestions 120 pertinent to the current state. If needed, in some embodiments timeline scheduler 110 also generates (over interface 118), external notifications 121 and external actions 122. An example of an external action 122 is making a reservation to a restaurant or movie using an automated API exposed by online ticketing services. An example of an external notification 121 is an automated message that is sent either by solicitation, or in an unsolicited manner, to select recipients in a meeting when a user is late for a meeting and the user is unable to reach the selected recipients. In some embodiments, this service is available if the personal assistant is resident on a network; e.g., the present system responds to an email on behalf of the user, like an auto-generated “out of office” mail, even when the user is not in a capacity to respond to the email.

Synthetic event generator 111 generates synthetic appointments and injects them into timeline 113, honoring space and time constraints. An example is generating an appointment for dinner at a restaurant automatically performed by external action 122, and once done, injecting the appointment into timeline 113. If the user chooses to fly back sooner than planned because a meeting finished early and the user chooses to catch an earlier flight, the present assistant initiates the cancellation on behalf of the user too.

Timeline 113 illustrates an embodiment where two appointment threads, appointment thread 114 and appointment thread 116, are shown with each thread having individual appointment nodes 115 dependant on each other. In some embodiments, the rendering interface for the present personal assistant is a combination of a calendar-like interface along with interfaces for suggestions and notifications. In other embodiments, a new interface is proposed that captures all of these three elements in a single interface. Regardless of the rendering interface, in some embodiments the inputs to the user interface are the elements illustrated in shaded box 112: timeline 113 with appointment threads 114, 116, suggestions 120, and notifications 119.

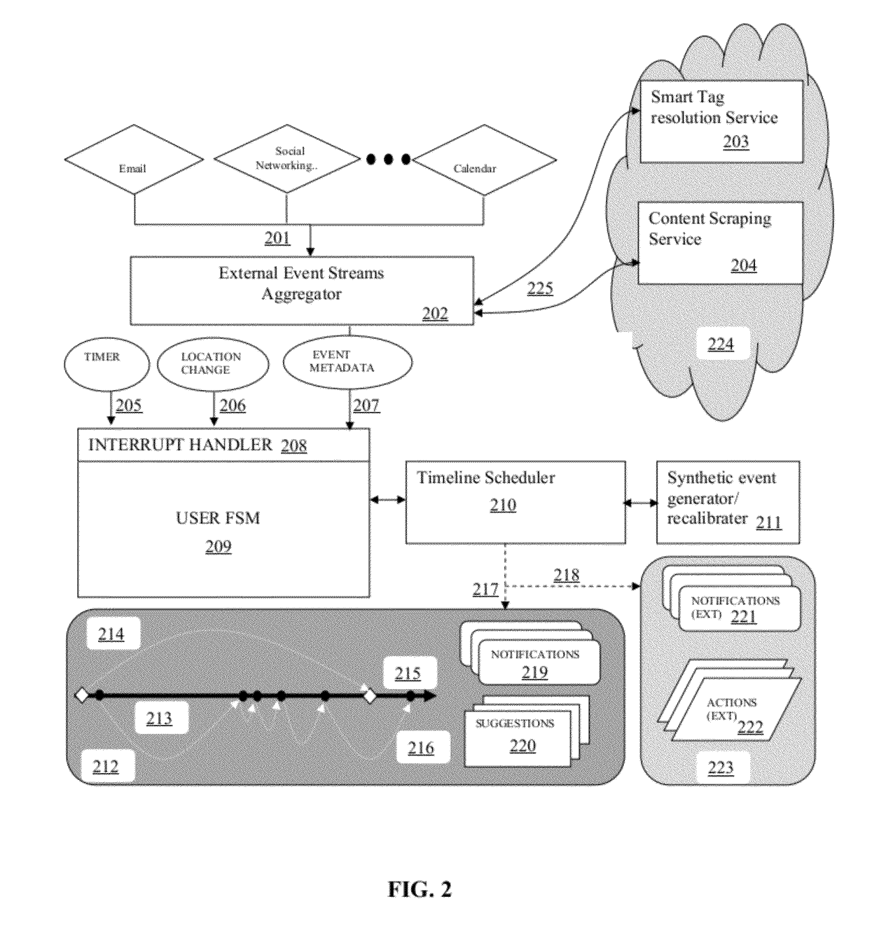

FIG. 2 illustrates an embodiment of the present personal timeline assistant system where some services required by the present personal timeline assistant are resident on a remote server, while the remaining portion of the present system is resident on a mobile device. FIG. 2 includes elements 201-223 which correspond to elements 101-123 as described in connection with FIG. 1, network 224, and interface 225. In FIG. 2, smart tag resolution service 203 and content scraping service 204 are resident on network 224. In this scenario, external aggregator 202 is resident on the user's device and external aggregator 202 communicates (over interface 225) with smart tag resolution service 203 and content scraping service 204, both resident on network 224.

In some embodiments, where the device has sufficient memory, smart tag resolution service 203 also resides on the device. In some embodiments, content scraping service 204 resides on the device. In such case, for example, the present system includes a seamless method of updating content scraping service 204 to provide, for example, for whenever an update to the template and/or a change to an existing template or a new template is required and the template is not currently resident on the device.

In some embodiments, if smart tag resolution service 203 and content scraping service 204 are resident in network 224, the present system dispatches the requests in a secure manner for privacy protection, and the services offer their services in a stateless manner, making the requests as anonymous as possible. One advantage to the embodiment shown in FIG. 2 is that the embodiment keeps user state information on the device and uses the network sparingly, and in a stateless way, whenever required.

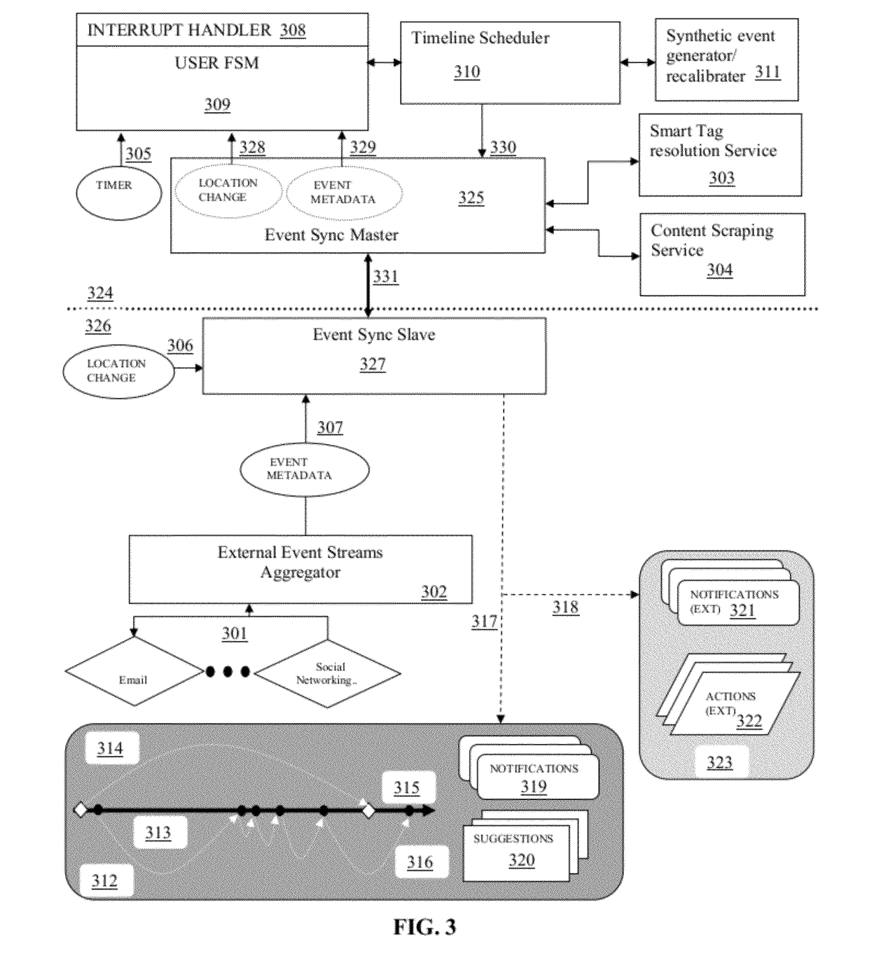

FIG. 3 illustrates an embodiment of the personal timeline assistant system where the mobile device serves purely as an events aggregator and rendering interface. As with FIG. 2, in FIG. 3 elements 301-323 correspond to elements 101-123 as described in connection with FIG. 1. FIG. 3 further includes event sync master 325, event sync slave 327, location change 328, updates 329, and interface 331. Event slave 327 dispatches (over interface 331) the aggregated events to the remote system. The remote system maintains the user's state (such as a signature of the user's past actions, etc.). Event sync master 325 on the server receives client updates and serves as a device proxy to FSM 309, as described earlier in connection with FIG. 2. Event sync master 325 also channels device events such as location change 328 and application information updates 329 to FSM 309. Event sync master 325 responds (over interface 331) to updates with rendering information over interface 317, timeline updates, and actions or notifications over interface 318 to the device, both of which are received from timeline scheduler 310. This embodiment has an advantage over the configuration described in connection with FIG. 2, in that the present personal assistant can continue to offer assistance even when the user is not accessible or is unable to communicate.

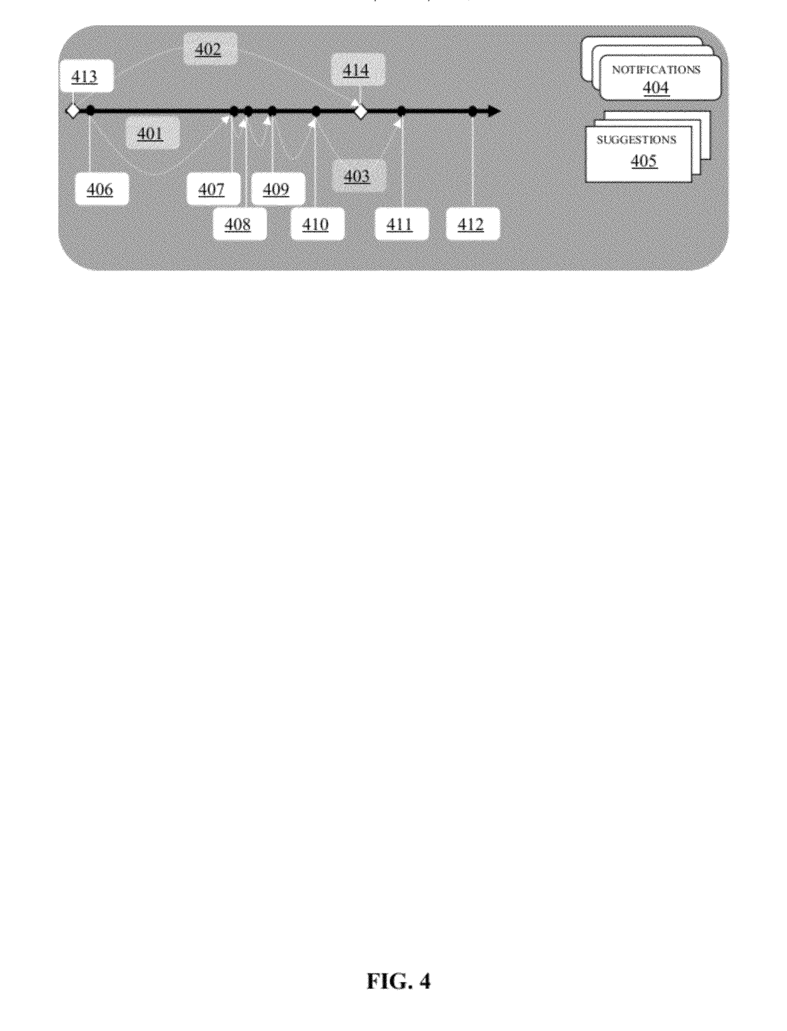

FIG. 4 illustrates an embodiment of a timeline with two independent appointment threads. The present system infers initially incomplete free-form scheduling information including appointment information about an appointment, and progressively updates appointments to approach completeness as appointments continue to come in. FIG. 4 includes timeline 401, appointment threads 402-403, notification list 404, suggestions 405, and nodes 407-414. For example, a user initially creates a calendar event with just an unstructured free-form note in the description “meeting at Veveo,” the date of the meeting, and the participants from Veveo (e.g. Murali, Daren). Timeline 401 begins with only one initial appointment node 411. As time progresses, when the present system receives appointments representing an airline reservation and car rental information, the present system infers appointment information about the appointments and about the appointment represented by initial appointment node 411. The appointment information enables the present system to resolve the location of Veveo in Andover, Mass., disambiguating multiple office locations of Veveo. The present system then adds additional appointment nodes 407-410 to the appointment thread.

If the present system receives a new appointment representing a dinner reservation event, synthetic event generator 111 (shown in FIG. 1) then adds appointment node 412 into timeline 401 representing the dinner reservation event. In FIG. 4, timeline 401 illustrates an embodiment of a timeline with two independent appointment threads 402, 403. Appointment threads 402, 403 have appointment nodes representing appointments inferred from a metadata stream of disparate event sources and synthetically generated appointments. Timeline 401 is not shown to scale. Appointment thread 402 is a personal appointment thread with two appointment nodes 413, 414 (illustrated by diamond-shaped nodes). Appointment thread 403 is a business appointment thread with six appointment nodes 406-411 (illustrated by circular-shaped nodes).

The present system periodically receives free-form scheduling information in the form of appointments from different sources, infers new appointment information based on the received appointments, and updates notification list 404 or suggestion list 405 with time, location change, and the new appointment information on appointments inferred from disparate sources. For example, in response to receiving free-form scheduling information as an airline booking email message, the present system infers and interprets appointment information from the airline booking email message and creates appointment node 406 showing that the user leaves for Boston from California. In response to receiving further free-form scheduling information such as an airline booking email message that the user has reached the Boston airport, the present system infers and interprets appointment information from the further airline booking email message, and creates appointment node 407.

In response to receiving free-form scheduling information such as a car rental confirmation link, the present system creates a suggestion using suggestion list 405 to show the user's car rental confirmation link. The present system further retrieves the user's car rental preferred customer number from the user signature and associates the number (e.g. AVIS Preferred) with the suggestion from suggestion list 405. In response to receiving a further car rental confirmation email, the present system infers and interprets appointment information from the further car rental confirmation email to create appointment node 408 showing, for example, the user has picked up the car from the car rental.

In response to free-form scheduling information such as the user's location change, the present system creates a suggestion from suggestion list 405 to show a hotel reservation email link. The present system further retrieves the user's airline miles membership card number from the user signature and adds the information to the suggestion, so that the user can receive miles for staying at the hotel. In response to receiving a web site link to a hotel booking site, the present system infers and interprets appointment information to create appointment node 409 representing the user's check in to the hotel.

In response to receiving free-form scheduling information such as a location change of the user's device, the present system creates a suggestion containing a phone number of a friend of the user, and triggering a reminder that the user is due to meet the friend shortly for lunch. In response to receiving free-form scheduling information such as a text message, the present system infers appointment information from the text message and creates appointment node 410 representing that the user meets a colleague for lunch at a restaurant.

In response to receiving a calendar event which itself contains free-form scheduling information, the present system infers appointment information from the calendar event and creates appointment node 411 representing that the user attends a meeting.

The present system further creates synthetic appointment node 412 representing a dinner reservation at the user's favorite restaurant, based on the user signature. The user's signature indicates the user always goes to this restaurant when he visits Boston—which is infrequent.

In response to receiving free-form scheduling information such as an AMAZON purchase confirmation email on the device, the present system infers and interprets appointment information from the purchase confirmation email and creates appointment node 413 representing that the user buys a book for delivery to a friend for the friend's birthday. For example, the present system interprets appointment information including gift wrap text mentioned in the purchase confirmation email which indicates the purchase is for the friend's birthday. Interpretation of this appointment information further triggers the present system to create synthetic appointment node 414. The present system infers and interprets appointment information from a social networking site for the friend's birthday to create synthetic appointment node 414. The present system infers and interprets appointment information by analyzing and verifying an unambiguous strong correlation of the friend's name between the social networking site and the shipping addressee name mentioned in the free-form scheduling information such as the AMAZON purchase confirmation email. This synthetic appointment node further triggers the present system to create a suggestion to call the friend on the friend's birthday, and to populate the suggestion with contact information for the friend from the device's contact book.

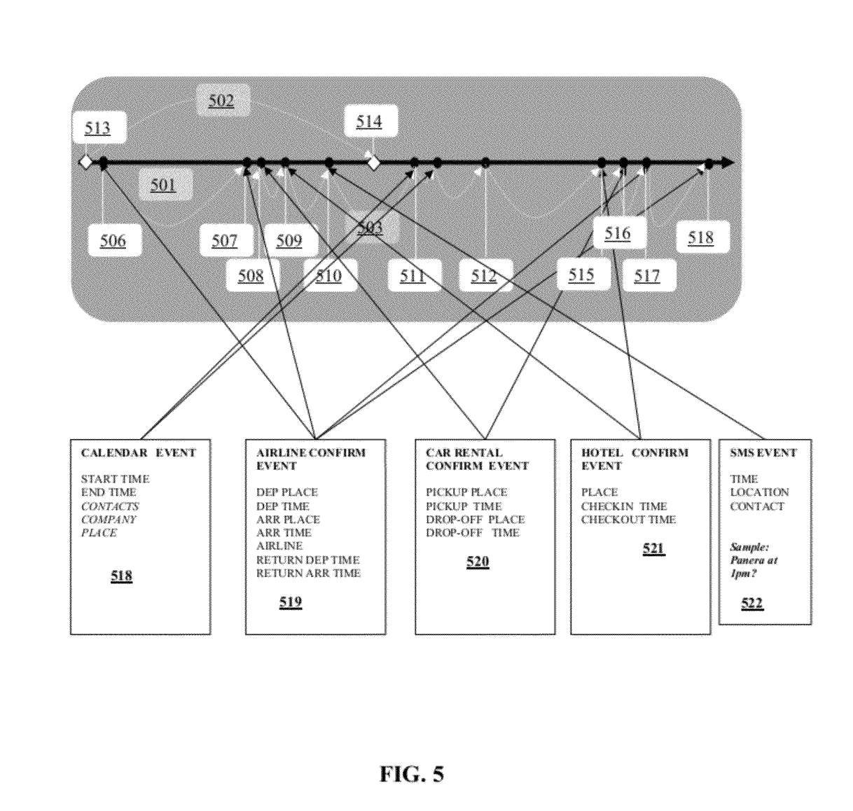

FIG. 5 illustrates creation of appointment nodes on the timeline based on events received from disparate data sources and occurring in a temporal order in accordance with some embodiments. FIG. 5 illustrates timeline 501, personal appointment thread 502, business appointment thread 503, and appointment nodes 506-518. As described earlier, the present system creates the application information in a timeline appointment node from receiving free-form scheduling information representing an event, and progressively updates the appointment node in response to receiving subsequent free-form scheduling information pertaining to that appointment node. FIG. 5 illustrates business appointment thread 503 in detail. Personal appointment thread 502, composed of appointment nodes 513, 514, corresponds to personal appointment thread 402 and appointment nodes 413, 414 (shown in FIG. 4). The present system infers appointment information from calendar event 518 such as start and end time, contacts, company, and place, and uses the appointment to create meeting nodes 511, 512. In response to receiving subsequent appointment 519 representing an airline confirmation event, the present system creates appointment nodes 506, 506, 517, 518 where appointment node 506 represents future departure to the meeting city, appointment node 507 represents future arrival at the meeting city, appointment node 517 represents future departure from the meeting city, and appointment node 518 represents future arrival at home. In response to car rental event 520, the present system creates appointment nodes 508, 516 where node 508 represents future pick-up and node 516 represents future drop-off of the rental car. In response to receiving hotel confirmation event 521, the present system creates appointment nodes 509, 515 where appointment node 509 represents future check-in and appointment node 515 represents future check-out. In response to receiving SMS event 522, the present system creates appointment node 510 for the user to meet a colleague for lunch prior to the meeting.

The present system uses information in the user signature about the user's preferences from past visits to the city where the meeting is being held, to create appointment node 512 representing a synthetic appointment node. Appointment node 512 represents a reservation made on behalf of the user. In other embodiments, appointment node 512 is not a synthetic appointment node, but a suggestion to the user. Upon receiving a click on the suggestion, the present system creates appointment node 512 in response.

In some embodiments, the present system disambiguates appointments based on appointment information inferred from free-form scheduling information representing a received event, and based on user confirmation of the disambiguation. For example, the first appointment is appointment nodes 511, 512 created from calendar event 518 in which the user simply entered “John.” If the address book on the user's device contains two Johns (e.g., John Smith and John Jones), the present system is unable to disambiguate between the two ambiguous names. Upon further receipt of airline confirmation event 519, the present system sets the destination city to be San Francisco. If both Johns have addresses near San Francisco, the present system would still have difficulty disambiguating calendar event 518. However, if the user signature indicates there has been more communication with John Smith than John Jones based on past actions (such as phone calls, emails, SMS, social network interactions etc.), then the system could request and process user confirmation to resolve the ambiguity. For example, the present system poses a question to the user such as “did you mean John Smith?” Upon receipt of the user's choice, the present system proceeds to create further synthetic appointments or actions, if any. In further embodiments, the system processes the user's choice to update the user signature for use in future processing.

In some embodiments, the present system disambiguates appointments based on appointment information from a received appointment if the appointment information represents confidence greater than a system threshold. For example, if the user simply has “John” in the calendar but John Jones lives in Texas, receipt of an airline confirmation for a flight to San Francisco allows the present system to disambiguate the Johns and to narrow the calendar appointment to John Smith. The present system proceeds to create synthetic appointment nodes if any, implicitly assuming the calendar appointment refers to John Smith. In this scenario, the present system resolves the ambiguity beyond a system threshold and thereby does not require the user to disambiguate explicitly between the two possibilities.

In some embodiments, the present system disambiguates appointments based on appointment information determined from free-form unstructured data in a received appointment. For example, the user types “John X-Company” as a text description, where X-Company has a branch in San Francisco and in Ottawa, Canada. The present system may have ambiguity as to where the meeting will be held. The user then adds to the calendar event another name that he learns is attending the meeting, for example based on a phone call. At this point, the calendar event contains the following free-form unstructured data: “John X-Company Pat.” The user has an entry for Pat in his contact list, in company X-Company. Moreover, Pat's office address indicates San Francisco. In such a case, the present system considers this appointment information or metadata to be sufficiently strong to disambiguate the meeting location, and converges on San Francisco as the meeting place because Pat resides in San Francisco. Upon receipt of an airline confirmation event to an airport in San Francisco, the present system further corroborates this conclusion.

The present system constantly adapts to the real-time appointment stream by adjusting synthetic appointments to be in line with the user's presence in time and space. For example, the airline confirmation event may be for an airport in another branch location. Accordingly, the present system adjusts its synthetic appointments to be in line with the user's presence in time and space by recomputing and adjusting the synthetic appointments in accordance with the new meeting location. In a further embodiment, because constant determination of the user's location may drain battery power, the present system only performs a location check when an appointment node is current, or when an external event occurs.

The present system includes multiple disambiguating factors. While location is a factor in influencing the timeline, time alone can also be a factor. For instance, when a user is supposed to be on a conference call at a particular time, that event could happen regardless of where the user is. (Boundary conditions may make the user inaccessible, for example if the user is in flight. In some instances, airplanes have means to permit the user to communicate with a party on the ground.) In some embodiments, the present system offers visual cues to the user indicating a tight schedule when a conference call is sandwiched in a travel plan, even if in reality there is no real-time conflict (e.g., if the meetings do not collide, but the travel to a meeting is overlapping). These visual cues are similar to a personal secretary or assistant asking if the user does indeed want to take a conference call on the way to a different meeting.

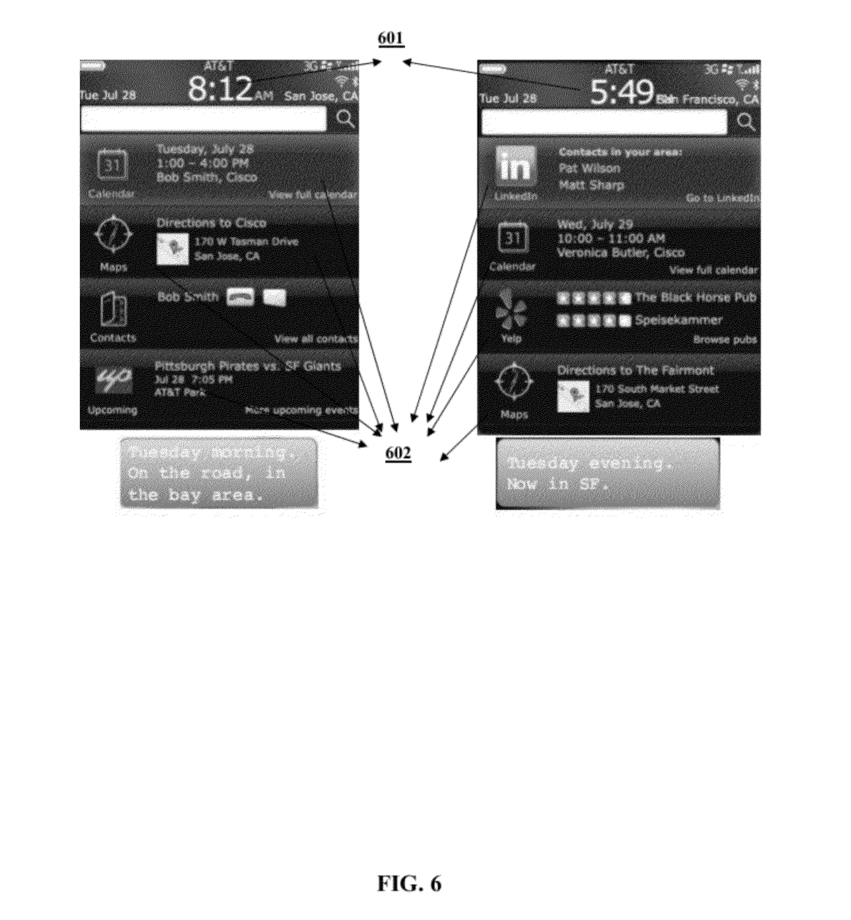

FIG. 6 illustrates a user interface shown when a user travels to San Jose for a meeting in accordance with some embodiments. FIG. 6 includes a time 601 and notifications 602. The interface presents elements of the timeline and suggestions in a simple interface in the home screen of a phone. The interface displays notifications 602 in temporal order of relevance taking into account user location. Time 601 and the user's location determine the notifications 602 or suggestions presented on the user interface, in addition to dynamic changes of semantics interpreted from event stream data (“flight delayed” SMS, etc.).

The user interface presents appointments representing events of relevance to a user based on time 602 and the user's location. The user interface aggregates multiple appointment threads such as personal appointment thread 502 and business appointment thread 503 (shown in FIG. 5). The user interface arranges and presents the appointments in a temporal and spatial order useful to the user. For example, FIG. 6 illustrates a user interface presenting notifications aggregated from a Calendar app, a Maps app populated from an email which the present system analyzes and interprets, and a YELP business recommendation service app based on the user's location.

On the left-hand side, FIG. 6 illustrates the user landing in the Bay Area for a meeting at CISCO. The present system infers appointment information about the meeting from free-form scheduling information in an electronic notification such as an email or calendar event. The user interface presents directions to CISCO based on business appointment thread 503 (shown in FIG. 5). In some embodiments, these directions are sufficiently granular for the present system to know the office belonging to the CISCO employee whom the user is meeting. The present system infers this information from electronic notifications including emails and calendar events, and displays the appropriate office building as a destination. Also displayed as a notification 602, the CISCO employee's name is Bob Smith. The present system displays Mr. Smith's phone number, allowing the user to call and let Mr. Smith know the user is on his way, running late, etc.

The user interface further aggregates personal appointment thread 502 (shown in FIG. 5). Based on the user signature, the present system knows the user is interested in the Pittsburgh Pirates. Based on the user's location in the Bay Area, the user interface displays a notification matching the user's sports interests, showing that the Pittsburgh Pirates are playing against the San Francisco Giants. The user interface ranks and displays this notification after the main appointments described above, since the relevance metric of this notification is lower and the notification occurs later in the day.

On the right-hand side, FIG. 6 illustrates a LINKEDIN notification based on personal appointment thread 502 (shown in FIG. 5) representing a synthetic appointment illustrating serendipitous discovery of a prior contact or friend. The user interface further displays a meeting appointment based on business appointment thread 503 (shown in FIG. 5) scheduled for the next day so the user can plan ahead. The user interface further displays recommendations for dinner at the Black Horse Pub or Speisekammer, and directions to The Fairmont hotel based on free-form scheduling information in a hotel confirmation email received by the present system.

Other examples of user interfaces include showing appointment nodes and suggestions or notifications using a combination of a calendar application user interface combined with a suggestion or notification user interface.

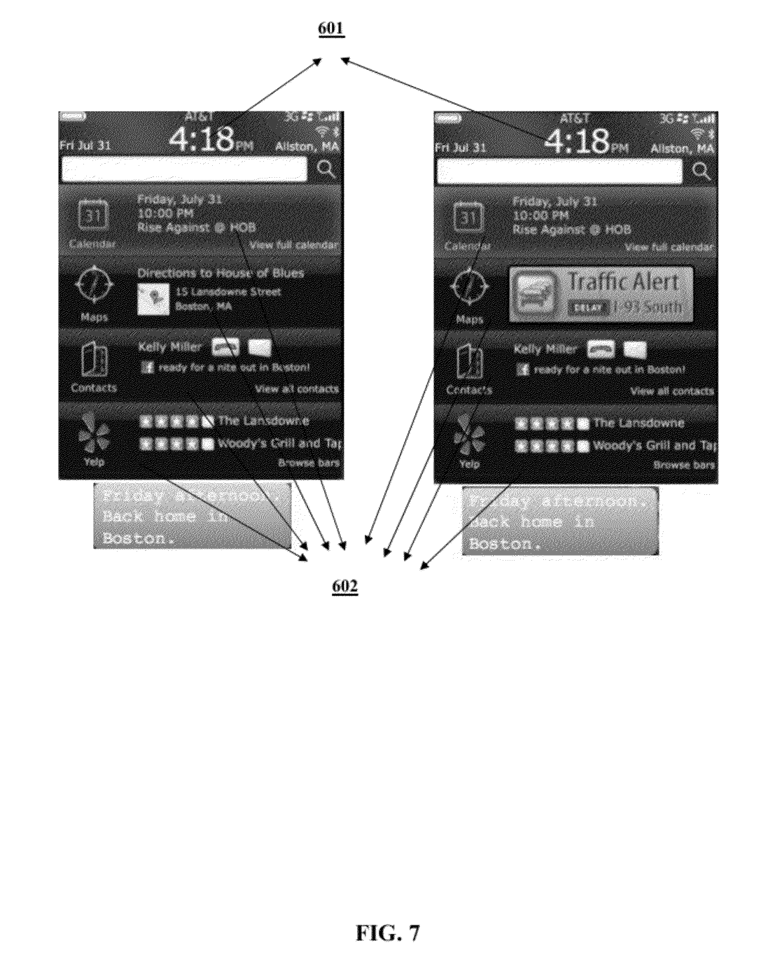

FIG. 7 illustrates a user interface shown when a user is at a home city in Massachusetts in accordance with some embodiments. FIG. 7 includes the time 601 and the notifications 602. The user interface updates dynamically based on time 601 and the user's location. When the present system receives an electronic notification representing a live status update of relevance to the user, the user interface updates to display the update. For example, in response to an electronic notification representing a traffic update, the user interface displays a delay en route in the form of a Traffic Alert on Interstate 93 South.

Nonlimiting examples of suggestions or notifications which the present system can make include displaying weather of a destination city in advance of a trip, displaying a frequent flyer number or car rental membership when needed, showing a pre-fetched map of a destination city to which a user is travelling as soon as the present system determines the user has landed, displaying phone numbers of persons with whom a meeting is scheduled as soon as the present system determines the user lands (so that when the user turns on the device frantically on the tarmac to call to say he or she is running late, the present system displays numbers of some or all of the meeting participants on the device without the user having to perform any search), making a reservation for dinner at a favorite place one always visits when making a business trip to a particular city, reminding the user to call a friend on the friend's birthday (which happens to fall on the same day that the user is traveling to a business meeting) for whom the user just bought a book which shipped a few days ago.

What is claimed is:

1. A computer-implemented user interface method of assisting a user in managing a timeline of appointments in which at least one of the appointments is associated with an event, and the appointment has associated appointment information that describes aspects of the appointment and/or the event, the method comprising:
receiving free-form scheduling information from an electronic notification;
inferring that at least a portion of the free-form scheduling information relates to an appointment existing on a timeline of appointments and/or an event associated with the existing appointment, the existing appointment having presently associated appointment information that describes aspects of the appointment and/or the associated event;
selecting an appointment for modification; and
modifying the selected appointment based on
(a) the portion of the free-form scheduling information inferred to relate to the existing appointment and/or the associated event, and
(b) at least one of (i) the appointment information presently associated with the existing appointment, and (ii) a user preference signature representing prior actions performed by the user and/or content preferences learned about the user.

2. The method of claim 1, wherein the existing appointment and/or the selected appointment includes (i) appointment information that describes aspects of the appointment and/or the associated event, (ii) an action to be performed on behalf of the user, (iii) a notification to update the user, and/or (iv) a suggested action for the user to take.

3. The method of claim 1, wherein the electronic notification includes an email message, a calendar appointment, a task, an application, notes application data, a social network event, a web site event, a text message, an electronic communication, and/or location information of the user.

4. The method of claim 1, wherein the associated appointment information includes an event type, one or more individuals involved with the event, location information about the event, and/or temporal information about the event.

5. The method of claim 1, wherein the modifying the selected appointment includes:
identifying ambiguous appointment information in the selected appointment; and
identifying at least one suggested clarification to the ambiguous appointment information based on the portion of the free-form scheduling information.

6. The method of claim 5, wherein the modifying the selected appointment further includes:
receiving confirmation from the user on whether the suggested clarification resolves the ambiguous appointment information; and
updating the selected appointment based on the suggested clarification and on the confirmation from the user.

7. The method of claim 5, wherein the modifying the selected appointment further includes:
concluding that the suggested clarification resolves the ambiguous appointment information based on exceeding a confidence threshold; and
updating the selected appointment based on the suggested clarification.

8. The method of claim 5, wherein the identifying at least one suggested clarification is based on free-form text entered in a description of the selected appointment.

9. The method of claim 1, wherein the modifying the selected appointment is based on a location constraint and/or a time constraint.

10. A computer-implemented user interface method of assisting a user in managing a timeline of appointments in which at least one of the appointments is associated with an event, and the appointment has associated appointment information that describes aspects of the appointment and/or the event, the method comprising:
receiving free-form scheduling information from an electronic notification;
inferring that at least a portion of the free-form scheduling information relates to a new appointment to be created on a timeline of appointments, the new appointment being associated with an event;
determining appointment information for the new appointment based on (i) the portion of the free-form scheduling information inferred to relate to the new appointment and/or the associated event, and (ii) a user preference signature representing prior actions performed by the user and/or content preferences learned about the user; and
creating the new appointment using the determined appointment information.

11. The method of claim 10, wherein the new appointment includes (i) an action to be performed on behalf of the user, (ii) a notification to update the user, and/or (iii) a suggested action for the user to take.

12. The method of claim 10, wherein the electronic notification includes an email message, a calendar appointment, a task, an application, notes application data, a social network event, a web site event, a text message, an electronic communication, and/or location information of the user.

13. The method of claim 10, wherein the determined appointment information includes an event type, one or more individuals involved with the event, location information about the event, and/or temporal information about the event.

14. The method of claim 10, wherein the creating the new appointment is based on a location constraint and/or a time constraint.

15. A system for assisting a user in managing a timeline of appointments in which at least one of the appointments is associated with an event, and the appointment has associated appointment information that describes aspects of the appointment and/or the event, the system comprising:
a computer memory store comprising instructions in computer readable form that when executed cause a computer system to
receive free-form scheduling information from an electronic notification;
infer that at least a portion of the free-form scheduling information relates to an appointment existing on a timeline of appointments and/or an event associated with the existing appointment, the existing appointment having presently associated appointment information that describes aspects of the appointment and/or the associated event;
select an appointment for modification; and
modify the selected appointment based on
(a) the portion of the free-form scheduling information inferred to relate to the existing appointment and/or the associated event, and
(b) at least one of (i) the appointment information presently associated with the existing appointment, and (ii) a user preference signature representing prior actions performed by the user and/or content preferences learned about the user.

16. The system of claim 15, wherein the existing appointment and/or the selected appointment includes (i) appointment information that describes aspects of the appointment and/or the associated event, (ii) an action to be performed on behalf of the user, (iii) a notification to update the user, and/or (iv) a suggested action for the user to take.

17. The system of claim 15, wherein the electronic notification includes an email message, a calendar appointment, a task, an application, notes application data, a social network event, a web site event, a text message, an electronic communication, and/or location information of the user.

18. The system of claim 15, wherein the associated appointment information includes an event type, one or more individuals involved with the event, location information about the event, and/or temporal information about the event.

19. The system of claim 15, wherein the computer memory store instructions to modify the selected appointment include instructions to:
identify ambiguous appointment information in the selected appointment; and
identify at least one suggested clarification to the ambiguous appointment information based on the portion of the free-form scheduling information.

20. The system of claim 19, wherein the computer memory store instructions to modify the selected appointment further include instructions to:
receive confirmation from the user on whether the suggested clarification resolves the ambiguous appointment information; and
update the selected appointment based on the suggested clarification and on the confirmation from the user.

21. The system of claim 19, wherein the computer memory store instructions to modify the selected appointment further include instructions to:
conclude that the suggested clarification resolves the ambiguous appointment information based on exceeding a confidence threshold; and
update the selected appointment based on the suggested clarification.

22. The system of claim 19, wherein the computer memory store instructions to identify at least one suggested clarification are based on free-form text entered in a description of the selected appointment.

23. The system of claim 15, wherein the computer memory store instructions to modify the selected appointment are based on a location constraint and/or a time constraint.

24. A system for assisting a user in managing a timeline of appointments in which at least one of the appointments is associated with an event, and the appointment has associated appointment information that describes aspects of the appointment and/or the event, the system comprising:
a computer memory store comprising instructions in computer readable form that when executed cause a computer system to
receive free-form scheduling information from an electronic notification;
infer that at least a portion of the free-form scheduling information relates to a new appointment to be created on a timeline of appointments, the new appointment being associated with an event;
determine appointment information for the new appointment based on (i) the portion of the free-form scheduling information inferred to relate to the new appointment and/or the associated event, and (ii) a user preference signature representing prior actions performed by the user and/or content preferences learned about the user; and
create the new appointment using the determined appointment information.

25. The system of claim 24, wherein the new appointment includes (i) an action to be performed on behalf of the user, (ii) a notification to update the user, and/or (iii) a suggested action for the user to take.

26. The system of claim 24, wherein the electronic notification includes an email message, a calendar appointment, a task, an application, notes application data, a social network event, a web site event, a text message, an electronic communication, and/or location information of the user.

27. The system of claim 24, wherein the determined appointment information includes an event type, one or more individuals involved with the event, location information about the event, and/or temporal information about the event.

28. The system of claim 24, wherein the computer memory store instructions to create the new appointment are based on a location constraint and/or a time constraint.
